(19) United States
(12) Patent Application Publication
(10) Pub. No.: US 2019/0081993 A1
(43) Pub. Date: Mar. 14, 2019

(54) METHOD FOR SHARING USER SCREEN IN MULTIPLE REALITY ENVIRONMENT AND SERVER SYSTEM FOR THE METHOD

(71) Applicant: AKN KOREA INC., Seoul (KR)

(72) Inventor: Hyuk Hoon Shim, Seongnam-si (KR)

(21) Appl. No.: 15/700,195

(22) Filed: Sep. 11, 2017

(51) Int. Cl. H04L 29/06; G06F 3/0481; G06F 3/14; H04L 12/18; G02B 27/01; G06F 3/0484

(52) U.S. Cl. CPC H04L 65/1089; G06F 3/04815; G06F 3/1454; G06F 3/04845; H04L 12/1813; G02B 27/0172; G06F 3/04842; G06F 3/1423

(57) ABSTRACT

Provided herein is a method for sharing a user screen. The method for sharing a user screen includes: receiving a sharing command of a display screen of a user for content pre-stored or displayed in streaming; providing a list of sharers sharing the screen or sharing subjects getting a request of the screen sharing according to a first user interface; receiving a selection of the sharer or the sharing subject in the list according to the first user interface; and transmitting the screen or at least a part of content included in the screen so that the screen is displayed to the sharing subject.

### BACKGROUND OF THE INVENTION

### 1. Field of the Invention

The present invention relates to a method for sharing a user screen, and more particularly, to a method for sharing a screen displayed to a user in reality and virtual reality environment.

### 2. Description of the Related Art

With the development of Internet technology, users share images and texts related to their experiences online through social networking services and receive mutual opinions about them. Recently, various types of social networking services have been introduced, so users can share images, a moving picture, etc., besides texts and can be able to share their daily life with services that suit their tastes by looking at unique user interfaces and feedback methods according to service providing methods.

Recently, ages, audio information, and web link information may be shared within a messenger for real-time communication among users as one of these social networking services and opinions may be exchanged within the messenger in real time. In addition to specific media data, the messenger also provides a function of sharing a current PC screen of a user with other users.

However, until now, the screen sharing through the messenger has been made only by the limited method and a method for sharing a screen among multiple users and exchanging opinions in the social networking service in which the users exist has not yet been proposed.

In addition, there is no social networking service that provides a method for solving a copyright problem due to the screen sharing when content related to copyright such as movie or music is displayed on a screen of a specific user.

In addition, current users are receiving not only realities but also content in a variety of environments such as augmented reality, virtual reality, and mixed reality.

Therefore, a need for sharing a screen as described above may arise even in realities where various environments coexist, and solutions to this may also be required for users in the upcoming future.

### SUMMARY OF THE INVENTION

An object of the present invention is to provide a method for sharing a screen of a user with another user during execution of media data.

Another object of the present invention is to provide a user interface for providing a screen shared with multiple users during execution of media data.

Another object of the present invention is to provide a method for processing a copyright problem with sharing of media data on a social network.

Another object of the present invention is to provide a method for sharing a user screen in multiple environment in which various realities coexist.

Another object of the present invention is to provide a method for controlling a shared screen of a user in multiple environment in which various realities coexist using a gesture that a terminal used by a user can recognize.

Another object of the present invention is to provide a method for efficiently using a network resource by separating reality screen data of a user from data of a virtual object part and transmitting the separated reality screen data.

Another object of the present invention is to provide a method for guaranteeing identity of content among shared users by synchronizing screens displayed to the users.

According to an exemplary embodiment of the present invention, a method for sharing a user screen may include: receiving a sharing command of a display screen of a user for content pre-stored or displayed in streaming; providing a list of sharers sharing the screen or sharing subjects receiving the shared screen according to a first user interface; receiving a selection of the sharer or the sharing subject in the list according to the first user interface; and transmitting the screen or at least a part of content included in the screen so that the screen is displayed to the sharing subject.

The screen displayed to the sharing subject may be displayed together in at least a part of the screen displayed to the sharer according to a second user interface.

In the providing, a selection menu of a sharing mode of the screen may be provided according to the first user interface.

In the transmitting, an image data output to the screen or the content included in the screen may be transmitted to the sharing subject in the streaming.

In the transmitting, the content may be transmitted to the sharing subject in the streaming through a media data server managing the content by referring to sync provided to the sharer.

In the transmitting, a data for a unit time of the content may be transmitted in the streaming based on the sync.

The second user interface may include an interface element for switching the screen of the sharing subject displayed in the one area to an image of the sharing subject or an avatar image of the sharing subject.

The first user interface may include an interface element for selecting at least a part of the content included in the screen.

According to another exemplary embodiment of the present invention, a server system may include: a memory; a processor; and a sharer screen sharing module included in the memory and executed by the processor, in which the sharer screen sharing module may perform: receiving a sharing command of a display screen of a user for content pre-stored or displayed in streaming; providing a list of sharers sharing the screen or sharing subjects getting a request of the screen sharing according to a first user interface; receiving a selection of the sharer or the sharing subject in the list according to the first user interface; and transmitting the screen or at least a part of content included in the screen so that the screen is displayed to the sharing subject.

According to another exemplary embodiment of the present invention, a computer-readable recording medium in which a program is stored, the program may execute: receiving a sharing command of a display screen of a user for content pre-stored or displayed in streaming; providing a list of sharers sharing the screen or sharing subjects getting a request of the screen sharing according to a first user interface; receiving a selection of the sharer or the sharing subject in the list according to the first user interface; and transmitting the screen or at least a part of content included in the screen so that the screen is displayed to the sharing subject.

According to another exemplary embodiment of the present invention, a method for sharing a user screen may include: receiving a sharing command of a display screen of a user for a received real object of reality environment and a virtual object pre-stored or streamed; providing a list of sharers sharing the screen or sharing subjects getting a request of the screen sharing according to a first user interface; receiving a selection of the sharer or the sharing subject in the list according to the first user interface; and transmitting the screen or at least a part of the real object or the virtual object included in the screen so that the screen including at least one of the real object and the virtual object is displayed to the sharing subject.

In the transmitting, the real object may be steamed to the sharing subject by dividing the real object and the virtual object and an object data of the virtual object may be transmitted to the sharing subject.

The method may further include: receiving a command of the sharer or the sharing subject for the shared virtual object as an object control command and processing the transmitted object data according to the object control command to mutually share the processed result.

In the transmitting, an image of the sharer or an avatar image of the sharer may be transmitted together.

In the transmitting, the image of the sharer received through a sharer terminal providing augmented reality to the sharer may be transmitted to the sharing subject.

In the transmitting, the avatar image of the sharer may be transmitted to the sharing subject through the sharer terminal providing virtual reality or mixed reality in which virtual and augmented realities are mixed to the sharer.

According to still another exemplary embodiment of the present invention, a server system may include: a memory; a processor; and a sharer screen sharing module included in the memory and executed by the processor, in which the sharer screen sharing module may perform receiving a sharing command of a display screen of a user for a received real object of reality environment and a virtual object pre-stored or streamed; providing a list of sharers sharing the screen or sharing subjects getting a request of the screen sharing according to a first user interface; receiving a selection of the sharer or the sharing subject in the list according to the first user interface; and transmitting the screen or at least a part of the real object or the virtual object included in the screen so that the screen including at least one of the real object and the virtual object is displayed to the sharing subject.

According to still yet another exemplary embodiment of the present invention, a computer-readable recording medium in which a program is stored, the program may execute: receiving a sharing command of a display screen of a user for a received real object of reality environment and a virtual object pre-stored or streamed; providing a list of sharers sharing the screen or sharing subjects getting a request of the screen sharing according to a first user interface; receiving a selection of the sharer or the sharing subject in the list according to the first user interface; and transmitting the screen or at least a part of the real object or the virtual object included in the screen so that the screen including at least one of the real object and the virtual object is displayed to the sharing subject.

### BRIEF DESCRIPTION OF THE DRAWINGS

FIG. 1 is a diagram illustrating an example of a configuration of a system in which a method for sharing a user screen according to an exemplary embodiment of the present invention is performed.

FIG. 2 is a block diagram illustrating a configuration of a sharing server according to an exemplary embodiment of the present invention.

FIG. 3 is a flow chart illustrating a method for sharing a user screen according to an exemplary embodiment of the present invention.

FIGS. 4A to 4E are diagrams illustrating a user interface according to an exemplary embodiment of the present invention.

FIG. 5 is a block diagram illustrating a copyright information management unit according to an exemplary embodiment of the present invention.

FIG. 6 is a diagram illustrating an example of a configuration of a system in which a method for sharing a user screen in multiple environment according to an exemplary embodiment of the present invention is performed.

FIG. 7 is a diagram illustrating an example of sharing a user screen in multiple environment according to an exemplary embodiment of the present invention.

FIG. 8 is a diagram illustrating an example of a configuration of a system in which a method for sharing a user screen in heterogeneous environment according to an exemplary embodiment of the present invention is performed.

FIGS. 9 to 12 are diagrams illustrating an example of sharing a user screen in heterogeneous environment according to an exemplary embodiment of the present invention.

FIG. 13 is a flow chart illustrating a method for sharing a user screen according to an exemplary embodiment of the present invention.

### DETAILED DESCRIPTION

The following description illustrates only a principle of the present invention. Therefore, those skilled in the art may implement the principle of the present invention and invent various devices included in the spirit and scope of the present invention although not clearly described or shown in the present specification. In addition, it is to be understood that all conditional terms and exemplary embodiments mentioned in the present specification are basically intended only to allow those skilled in the art to understand a concept of the present invention, and the present invention is not limited to exemplary embodiments and states particularly mentioned as such.

The above-mentioned objects, features, and advantages will become more obvious from the following detailed description provided in relation to the accompanying drawings. Therefore, those skilled in the art to which the present invention pertains may easily practice a technical idea of the present invention.

Further, when the detailed description of technologies known in the related art are considered to make the gist of the present disclosure obscure in the present disclosure, the detailed description thereof will be omitted. Hereinafter, exemplary embodiments of the present invention will be described in detail with reference to the accompanying drawings.

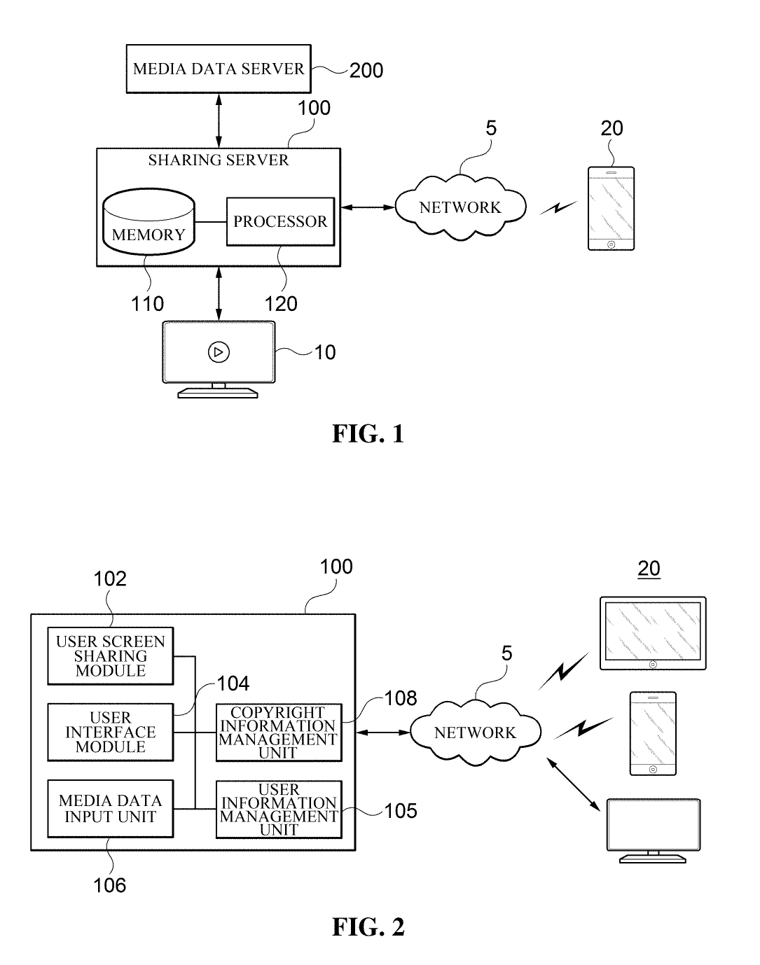

FIG. 1 is a diagram illustrating an example of a configuration of a system in which a method for sharing a user screen according to an exemplary embodiment of the present invention is performed.

Referring to FIG. 1, a system according to the present exemplary embodiment includes a sharing server 100 for sharing a user screen around a network 5, a media data server 200 for managing content included in the user screen, and a terminal 20 of a user and a sharing subject.

In the present exemplary embodiment, a side sharing a screen is defined as a sharer, and a side receiving the shared screen is defined as a sharing subject.

In FIG. 1, the sharer uses a PC 10 to share a screen including a video that he/she is viewing with a user terminal 20 of the sharing subject. At this time, the sharing server 100 executes a user interface for sharing a screen included in a memory 110 on the user's PC 10 using a processor 120, and shares the screen with the sharing subject, which is selected from the user, through the network 5.

In addition, the media data server 200 provides the content provided to the user to the sharing subject together with the sharing server 100, such that the screen is substantially shared. At this time, the media data server 200 is a non-essential component. If the user directly holds the content, the user can directly provide the content to the sharing subject through the sharing server 100 by the streaming. In addition, the user can guarantee the identity of content of the sharing subject and the sharer by providing current sync information while providing the content to the sharing subject.

On the other hand, if receiving the content managed by the media data server 200, the user may provide the content received at the time of sharing the user screen to the sharing subject through the media data server 200. Further, the media data server 200 may also be configured to provide content to the sharing subject and allow the sharer to directly transmit the sync information of the provided content to the sharing subject.

Alternatively, even in this case, the user PC can transmit the content provided by the streaming to the user terminal 20 of the sharing subject without intervention of the media data server 200.

the present exemplary embodiment, the content is provided to users and is media data that can be visually recognized, and may include data for a virtual object provided in the virtual reality as well as movies and music data that can be visually recognized in the reality environment.

In this way, if a device that a user uses is a device such as a smart phone, a tablet PC, and smart glasses, the user may share a screen in reality environment or augmented reality environment, and if the device that the user uses is a head mounted display (HMD), the user may share a displayed screen in augmented reality or mixed reality environment.

The media data server 200 may be at least one computing device, such as one or more server computer and a desktop computer, and may also implemented as a mobile device. In addition, each configuration of the media data server 200 may be integrated into the same physical or logical system as the sharing server 100 or different physical or logical systems.

In the present exemplary embodiment, the network 5 interconnects between the components of the system according to the present exemplary embodiment in a wired or wireless communication manner under the environment that users and sharing subjects can exchange information with each other.

As the wireless communication technology used in the network 5, a wireless LAN (WLAN) (Wi-Fi) technology, a wireless broadband (Wibro) technology, a world interoperability for microwave access (Wimax) technology, a high speed downlink packet access (HSDPA) technology, or the like, may be used. As another example, as a wired communication technology, a digital subscriber line (XDSL), a fiber to the home (FTTH), a power line communication (PLC), or the like may be used.

In addition, as a short range communications technology, a Bluetooth technology, a radio frequency identification (RFID) technology, an infrared data association (IrDA) technology, an ultra wideband (UWB) technology, a ZigBee technology, or the like, may be used.

In the present exemplary embodiment, the user terminal 20 includes a mobile device besides a PC such as a desktop. The mobile device may be a mobile (i.e., portable) computing device such as a mobile phone, personal digital assistant, a tablet computer, and a wearable computing device. In addition, the mobile device includes a device such as an HMD for providing the virtual environment.

Hereinafter, the configuration of the sharing server 100 according to the present exemplary embodiment will be described in more detail with reference to FIG. 2.

FIG. 2 is a block diagram illustrating a configuration of a sharing server 100 according to an exemplary embodiment of the present invention.

In the present exemplary embodiment, the sharing server 100 includes a user screen sharing module 102, a user interface module 104, a media data input unit 106, a copyright information management unit 108, and a user information management unit 105.

Each component of the sharing server 100 may be functionally implemented according to the memory 110, the processor 120, and other hardware devices (not illustrated) which are included in the sharing server 100 itself.

In addition, each component of the sharing server 100 may be dispersed according to the operation of the server, and may be implemented at the same time.

In the present exemplary embodiment, the user screen sharing module 102 provides a service for sharing information and mutual communication between the user and the sharing subject. That is, the sharing server 100 may directly configure a messenger between a user and a sharing subject and a social network environment for sharing and a screen, and control transmission/reception of information thereon.

Alternatively, it is possible to additionally provide a service for receiving social network information of a user according to user information from a social networking service subject operated by a separate service subject and sharing a screen based on the received social network information of the user.

That is, in the present exemplary embodiment, the user screen sharing module 102 may provide its own service including the reproduction of the content and the sharing of the screen to be reproduced, manage the social network information of the user according to the service, and allow the user to share the screen.

In this case, if the sharer and the sharing subject use the same service, it is possible to set not only the screen sharing, but also the reproduction options (sync, image quality, presence or absence of subtitle, subtitle language, etc.) of the content to be reproduced on the screen to be the same. In this way, the sharing subject may receive the content viewed by the sharer in the same state without any additional setting.

Alternatively, it is also possible to additionally provide a screen sharing function by using the social network information of the user on content providing services of other companies or social network information of a user on social networking services of other companies. In other words, if the screen is shared by interworking with services of other companies, various setting information related to the reproduction of the content besides the content may be provided together to guarantee the identity of the shared screen. Furthermore, the user screen sharing module may be implemented by API designed so that browsers may communicate with each other without the help of a plug-in like Web real time communication (WebRTC), and thus may easily interwork with even other social networking services or a video providing services through the browser.

In the present exemplary embodiment, the user interface module 104 may provide the user interface for sharing the screen, receive the input of the user according to the user interface, and control the operation of the sharing server 100 according to the user input.

In the present exemplary embodiment, the user interface may be configured of a user interface that selects the sharing subject for sharing the screen and a user interface that divides the screen and provides the divided screen to the user or the sharing subject according to the screen sharing. This will be described in more detail with reference to the drawings to be described below.

In the present exemplary embodiment, the media data input unit 106 may receive the media data of the content included in the screen at the time of the screen sharing of the user and may provide the received media data to the sharing subject.

In the present exemplary embodiment, the shared media data include data for the screen itself displayed on the display device through a graphic processing device of the user terminal 20, video/audio data of video/audio content provided through the screen and metadata for the content.

In addition, the media data may include data of various virtual objects that are computer graphically generated so as to be recognizable in the virtual reality environment, as well as in a form that can be directly recognized in real life.

The media data input unit 106 receives data and provides the received data to the shared data. In addition, in the present exemplary embodiment, the sharing subject may share the full screen of the user, or may select and share a part of the full screen.

For example, the full screen may be shared as it is, and thus the screen for a taskbar of an operating system displayed on the user screen, a mouse cursor of the user, and the like may be shared as it is. Alternatively, when the user views a video through a part of the screen, he/she may select a part of the video data to share only the video data.

Furthermore, although not directly displayed on the screen, it is also possible to share a program executed in the background on the operating system of the user terminal 10 and display the program on the terminal 20 of the sharing subject.

In other words, in the present exemplary embodiment, the media data inputted according to the screen sharing may include all data that is displayed on the display device or can be displayed among the data being executed on the user terminal 10.

In the present exemplary embodiment, the copyright information management unit 108 manages the copyright information related to the content included in the shared screen.

For example, if a user is viewing a movie through a desktop PC, the copyright information management unit 108 may manage digital right management (DRM) information when the movie is protected by the DRM.

Accordingly, when the screen on which the movie is being reproduced is to be shared with the sharing subject, the copyright information management unit 108 may determine whether the screen can be shared and calculate and charge copyright royalties that can be incurred at the time of the screen sharing. At this time, the billing target may be the sharing subject receiving the shared screen and/or the user sharing a screen.

In the present exemplary embodiment, the user information management unit 105 may manage the user information on the social networking service provided from the user screen sharing module 102, and provide a list of other users on the social network according to the user information through the user interface when the user requests the user interface for sharing the screen.

The sharing server 100 shares the screen between the user and the sharing subject at the time of the request of the screen sharing of the user by each component described above, and at the same time processes the copyright related matters of the content included in the shared screen.

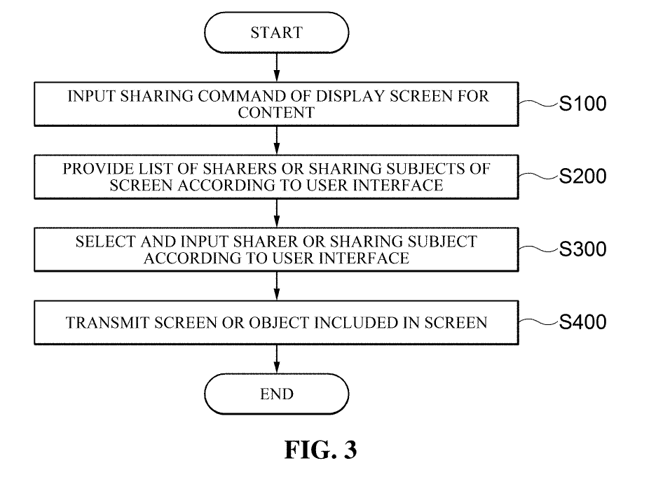

Hereinafter, a method for sharing a user screen according to the present exemplary embodiment will be described with reference to FIG. 3.

FIG. 3 is a flow chart illustrating a method for sharing a user screen according to an exemplary embodiment of the present invention.

The method for sharing a user screen according to the present exemplary embodiment includes receiving a sharing command for sharing a screen displayed to a user for sharing the screen (S100).

Next, a list of sharers or sharing subjects of the screen is provided according to a first user interface (S100).

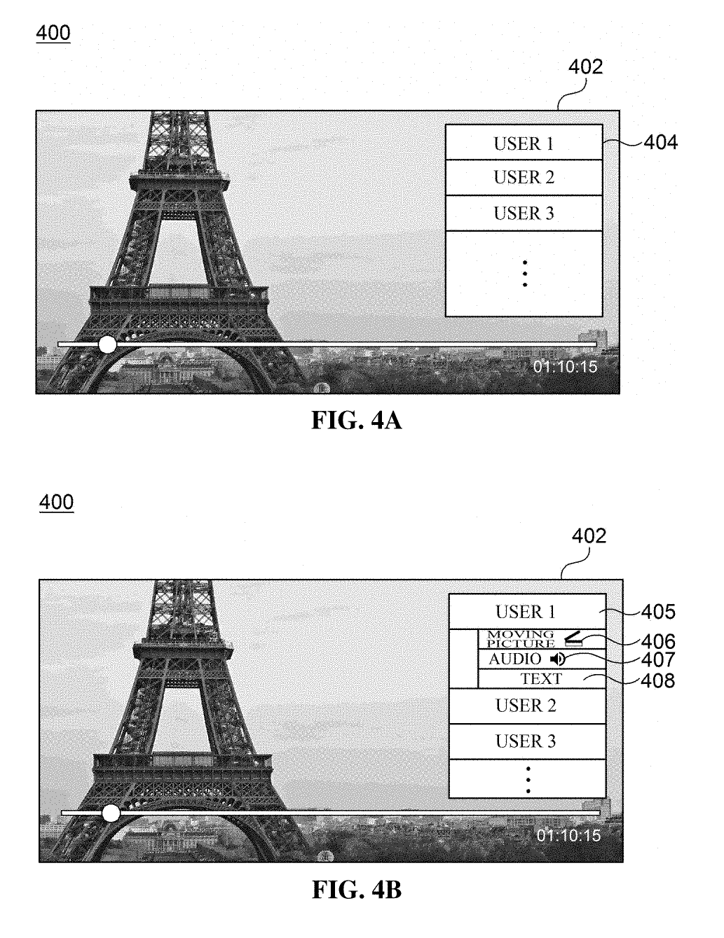

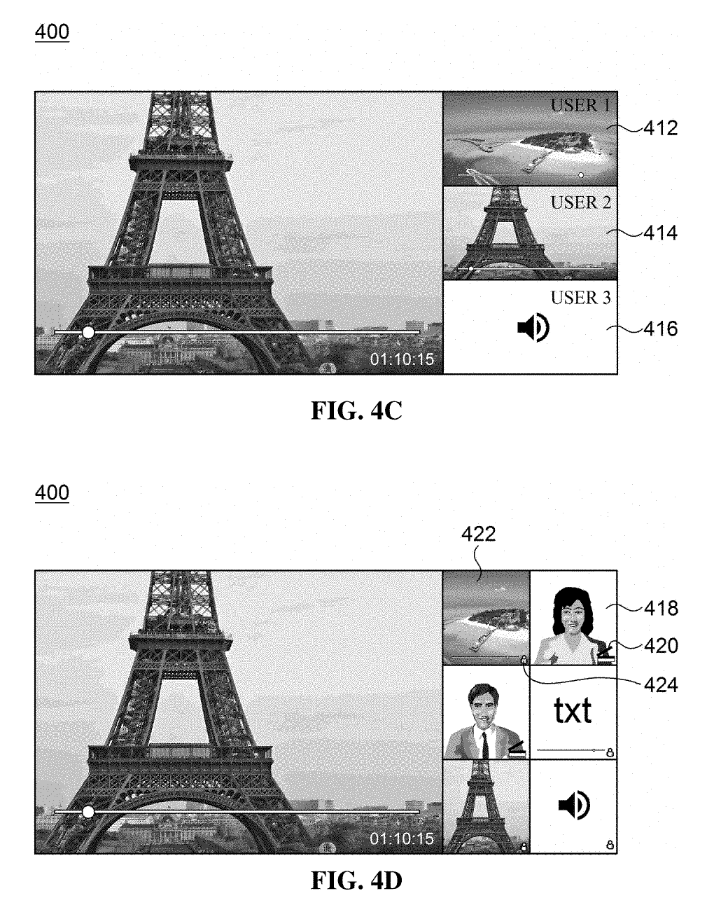

Hereinafter, the user interface according to the present exemplary embodiment will be described based on a screen 400 displayed on a display device with reference to FIGS. 4A to 4E.

The first user interface according to the present exemplary embodiment will be described in more detail with reference to FIG. 4A.

FIG. 4A is a diagram illustrating the first user interface according to the exemplary embodiment of the present invention.

FIG. 4A is a diagram illustrating a situation in which the screen 402 is shared with other users while a sharer views the moving picture on the full screen 402 in the present exemplary embodiment.

In the exemplary embodiment, when the sharer inputs a command for sharing the screen through a mouse, a touch input, or the like (S100), a list 404 of other users on a social network of a user may be provided to a part of the screen (S200).

The user interface is provided through the above-described sharing server 100, and if a sharing program used by a user is provided based on an application for executing a moving picture, the first user interface may be provided through the input of the screen sharing command on the user's application.

Alternatively, if the user interface is provided as the screen sharing service for the screen sharing executed separately from the application executing the moving picture is provided, the user interface may receive the first user interface through an input of a background command during the execution of the moving picture of the full screen.

Referring to FIG. 4A, a list of other users on the social network of the user may be displayed in a box 404 on a part of a screen of a moving picture to be reproduced on the full screen 402.

The step (S200) of providing the list of other users and the step (S100) of receiving the sharing command may also be performed in a reverse order. That is, the list of users is first provided, and the selection of the sharing subject in the provided list can be input as the sharing command.

In the present exemplary embodiment, if the list of other users is provided by the first user interface, the method for sharing a user screen includes receiving the selection of the sharing subject in the list according to the first user interface (S300).

In the present exemplary embodiment, the selection of the sharing subject can be performed through the first user interface with reference to FIG. 4A. If the user selects one of other users separately displayed within the box 404 displayed in one area of the screen by a mouse click or a touch input, the first user interface may select a user corresponding to a clicked or touched location as the sharing subject and receive it.

In addition, FIG. 4A illustrates displaying names or IDs of other user as texts, but the names or the IDs may be displayed as images that can identify the users.

In addition, in the present exemplary embodiment, the first user interface can also select content that may be provided to the sharing subject at the time of sharing the screen together with the selection of the sharing subject.

In the present exemplary embodiment, the screen sharing literally means sharing the screen itself in real time to provide the shared screen to other users as it is and share some of the content of the screen. In the latter case, the screen sharing may have the meaning as an initial input for sharing one of the contents of the user included in the screen.

For example, unlike FIG. 4A, if a user is reproducing the moving picture on a part of the screen rather than on the full screen, he/she can select whether to share a screen including a background, or the like different from a part of the screen on which the moving picture is reproduced or only a part of the screen on which the moving picture is reproduced.

In addition, even when the moving picture is reproduced on a par of the screen, it is possible to select whether to provide only the audio included in the moving picture, or to provide only the video or to provide only the text information such as subtitles.

Therefore, in the present exemplary embodiment, the screen sharing means providing various types of media to other users based on the content displayed on the screen.

Referring to FIG. 4B, in the present exemplary embodiment, the selection of the content to be provided to the sharing subject may be continuously performed through the first user interface according to FIG. 4A.

In the case of selecting the screen sharing with user 1 among other users in the box on the interface according to FIG. 4A (405), an interface for selecting the content to be shared with the user may be provided in an additional box.

Specifically, elements that may select the moving picture 406, the audio 407, and the text 408 may be displayed in an additional box of FIG. 4B.

In FIG. 4B, these elements are displayed together with a graphic user interface (GUI) element, and the user may select the moving picture through the GUI element to share the video and audio data, select the audio to share only the audio data, or select the text to share only the text data such as subtitles.

In addition, the step (S300) of receiving the selection of the sharing subject may be performed as a step of receiving the selection of the sharer from the terminal of the sharing subject. That is, the step (S200) of providing the list of other users as described above may be performed by providing the list of users to the terminal of the sharing subject.

For example, if the sharer can execute the moving picture and inputs only the intention to share the moving picture, the sharer may provide a moving picture, which can be currently shared, to other users (candidates of the sharing subjects) as the list of the sharing subjects.

In the present exemplary embodiment, the sharing subject checks the information on the sharer and the information of the content displayed on the screen of the current sharer through the list of the sharers, and if the sharing subject selects the sharer who the sharing subject wants to share, the sharing server 100 may receive a sharing command to allow the sharing subject to share the screen of the sharer and may allow the sharing subject to share the screen.

In addition, each of the sharing subjects cannot share the screen of the sharer but a plurality of sharing subjects can share the screen of the sharer. In other words, if the sharer inputs an intention to share a moving picture, a virtual screen sharing room such as a chat room is created, and the sharing subject may participate in a screen sharing room created by the sharer.

If the user selects content to be shared with the sharing subject through the user interface, in the present exemplary embodiment, the method for sharing a user screen includes transmitting at least some of content included in the screen so that the screen is displayed to the sharing subject (S400).

In the present exemplary embodiment, the method for sharing a user screen includes transmitting content, and if the content is displayed to the sharing subject, displaying the content on the user screen.

Specifically, in the present exemplary embodiment, the method for sharing a user screen may include displaying a screen displayed to the sharing subject in one area of the screen displayed to the user according to the second user interface.

Also, in the present exemplary embodiment, the user may perform a selection to share the screen with a plurality of users through the above-mentioned first user interface. At this time, the user may view a screen displayed to the sharing subject in one area of the screen according to the second user interface.

The user may check how the sharing subject is provided with the screen shared by him/her through the screen displayed to the sharing subject, and can provide additional information to the sharing subject according to an additional interface.

In addition, in the present exemplary embodiment, in the transmitting step S400, the screen or at least a part of the real object or the virtual object included in the screen can be transmitted so that the screen including at least one of the real object and the virtual object is displayed to the sharing subject.

That is, in addition to merely sharing the media data displayed on the display device in the reality environment, the real object and the virtual object are divided under the environment that the virtual reality coexists, so that the real object can be streamed to the sharing subject and the object data of the virtual object can be transmitted to the sharing subject.

FIG. 4C is a diagram illustrating the screen 400 of the user if the screen is shared with three sharing subjects by the method for sharing a user screen according to the present exemplary embodiment of the present invention, and illustrates the situation that each of the sharing subjects currently shares the screen. That is, the second user interface divides the user screen, and areas 412, 414, and 416 are divided according to the number of sharing subjects, thereby displaying the screen displayed to the sharing subject.

The reason of displaying the screen displayed to the sharing subject to the user is that the sharing subject may select a kind of content provided after the screen sharing or separately set the content providing matter, i.e., the screen sharing mode, in addition to merely sharing the screen by the method for sharing a user screen according to the present exemplary embodiment.

Referring to FIG. 4C, the user may check through the second user interface according to the present exemplary embodiment that the screen 412 of user 1 among the sharing subjects shares the video of the user sharing the screen and the user 1 views the video at different points of time by changing a reproduction point of time. In addition, it can be checked that the screen 414 of the user 2 views the video at the same reproduction time as the user screen. It can be checked that the screen 416 of the user 3 receives only audio data.

In addition, in the present exemplary embodiment, the division of the area of the sharing subject may be variously set for each sharing subject according to the sharing mode the screen. That is, the area may be equally divided for each sharing subject or the area may be divided by changing its size according to the importance.

Additionally, the second user interface according to the present exemplary embodiment may include an interface element for switching the screen of the sharing subject displayed in the one area into the image of the sharing subject.

This will be described in more detail with reference to FIG. 4D. FIG. 4D shows an example in which a user shares his/her screen with six sharing subjects in the present exemplary embodiment.

As described above, the second user interface divides the screen displayed to the sharing subject with respect to one area of the user screen 400 according to the number of sharing subjects, and displays them together.

In addition, a screen of each sharing subject includes an interface capable of performing a switching to an image of the sharing subject, so that the user can view the screen of the sharing subject or receive the video of the sharing subject, thereby performing the video communication.

In the present exemplary embodiment, the second user interface may further include a graphic user interface (GUI) element in each area of the sharing subject as an interface element for switching between the screen of the sharing subject and the image of the sharing subject.

Referring to FIG. 4D, the GUI elements are included in the lower right portion of the area of the sharing subject.

For example, a GUI element 424 for switching to an image of a user is included in the lower right side of the screen 422 of the user 1, and if the user selects the same, the image of the user 1 may be displayed. In addition, a GUI element 420 for switching to the user screen shared on the screen of the sharing subject is included in the lower right side of the screen 418 of user 2, thereby performing the switching of the screen.

In addition, in the present exemplary embodiment, in the step of transmitting the content (S400), the image data of the user can be further transmitted.

That is, the user may transmit the image of the user photographed by the camera module included in the user terminal 20 to the sharing subject while sharing the user screen with the sharing subject.

FIG. 4E illustrates an example in which the sharing subject receives the image 430 of the user while sharing the user screen 402. In the present exemplary embodiment, if the sharing subject receives the image 430 of the user, the image 430 of the user may be displayed in a lower end of the shared image.

At this time, the image sharing of the user may be used for the purpose of an additional explanation of the shared image, in addition to the purpose of allowing the sharing subject to perform the video communication with the user.

For example, when a user performs an additional description of content included in an image to the sharing subject through a sign language, the sharing subject can check it together with the image.

In addition, in the transmitting step in the multiple environment in which the virtual reality coexists, the image of the user or an avatar image of the user may be transmitted together. That is, one side of a user includes a camera facing a user's face, and if the user's face can be photographed, the image of the user may be transmitted to the sharer or the sharing subject.

Alternatively, in the case where there is no camera or photographing cannot be made, it is also possible to transmit the avatar image of the user instead.

That is, in the present exemplary embodiment, in additional procedure, a method for checking the terminal used by the user before the sharing or during the sharing and displaying it to other users according to the terminal of the user may be determined.

By doing so, when the sharer and the sharing subject communicate with each other through the object shared by the sharer and the sharing subject, the sensation of immersion may be improved.

When the user and the sharing subject share the screen with each other through the user interface of the user and the sharing subject, the sharing mode of the screen set by the user can be recognized by the other party and the image of the user may be shared together with the video to transmit the additional information.

In the present exemplary embodiment, the method for sharing a user screen can also execute the billing process for the sharing subject according to the screen sharing.

As described above, in the present exemplary embodiment, the sharing server 100 can process the copyright problem that may occur when the video is shared through the copyright information management unit 108.

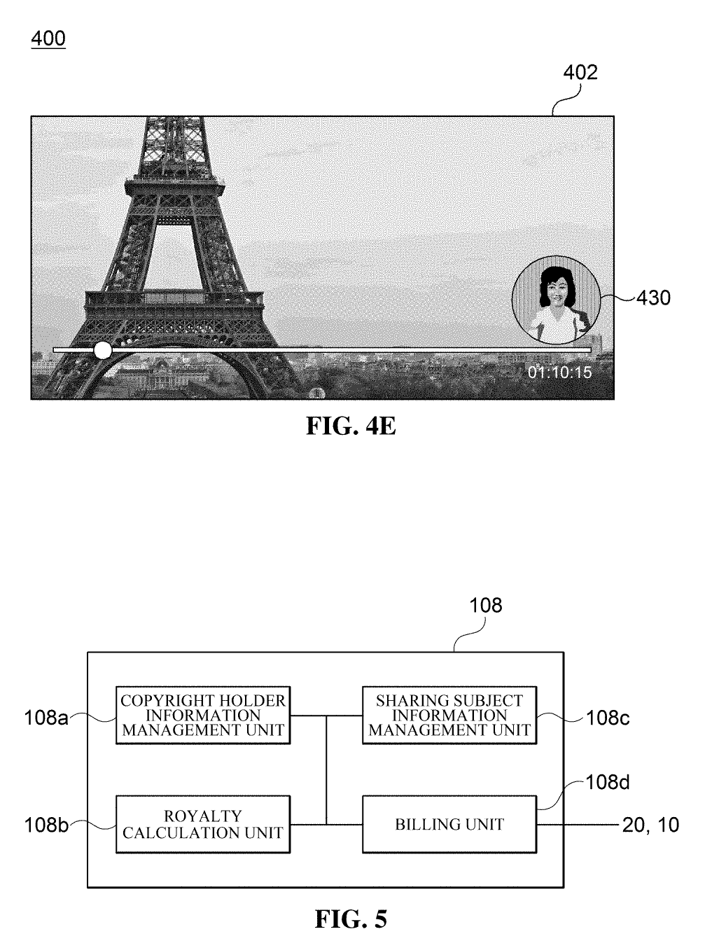

This will be described in more detail with reference to FIG. 5.

FIG. 5 is a block diagram illustrating the copyright information management unit 108 according to the exemplary embodiment of the present invention.

Referring to FIG. 5, in the present exemplary embodiment, the copyright information management unit 108 includes a copyright holder information management unit 108a, a royalty calculation unit 108b, a sharing subject information management unit 108c, and a billing unit 108d.

In the present exemplary embodiment, the copyright holder information management unit 108a manages the information of the copyright holder associated with the shared image. In the present exemplary embodiment, the copyright holder is a person who owns or manages the copyright of the shared image, and may be a subject who collects the royalty from the sharing subject or the user.

Therefore, in the present exemplary embodiment, the copyright information management unit 108 allows the calculated royalty to be paid by referring to the information of the copyright holder.

The royalty calculation unit 108b calculates the copyright according to the sharing of the image. At this time, the royalty calculation unit calculates royalties for each sharing subject. For example, the greater the number of sharing subjects with whom the user shares videos, the more the royalty can be calculated.

In addition, in the present exemplary embodiment, the sharing subject can set the sharing mode of the screen shared when the screen is shared, and it is also possible to reflect such setting information. For example, it is also possible to calculate the copyright royalties for the case of sharing the full image, the case of sharing only a part of the image, and the case of sharing only audio or text information.

That is, in the present exemplary embodiment, the billing process can compare the data amount of the transmitted contents for the plurality of sharing subjects to charge the cost to each sharing subject.

In the present exemplary embodiment, the sharing subject information management unit 108c manages the information on each of the sharing subjects for calculating the royalties by the royalty calculation unit 108b. The sharing subject information management unit 108c manages the information on the sharing mode of the screen of the sharing subject for each sharing subject and transmits it to the royalty calculation unit. In addition, in the case where the sharing subject information management unit 108c charges the royalty calculated by the billing unit 108d to each sharing subject, the sharing subject information management unit may provide the identification information of the sharing subject and individually execute the user interface for the billing.

In the present exemplary embodiment, the billing unit 108d charges the royalty calculated by the royalty calculation unit 108b to persons 10 and 20 to whom the royalty should pay. At this time, the billing unit 108d may execute a separate user interface for charging the cost on the screens of each sharing subject before sharing the image, thereby sharing the screen when the sharing authentication of the sharing subject is completed.

In addition, in the present exemplary embodiment, in addition to the billing method for each sharing subject who share the image as the billing method, the user can pay the royalty to the copyright holder as much as the screen shared by him/her and the user can separately charge the cost to the sharing subject.

For example, the user can utilize his/her social network to share a screen with a large number of other users, and receive the royalty included therein from each sharing subject.

In other words, in the present exemplary embodiment, the copyright information management unit 108 may perform various billing processes for each user and each sharing subject according to the sharing mode of the screen through the above-described configuration and process the collection of the royalty according to the use of the copyright by the screen sharing in a lump. Furthermore, the copyright information management unit 108 may first determine whether or not to share the screen according to the copyright, in addition to charging the cost based on the copyright and control screen sharing accordingly.

Hereinafter, in another exemplary embodiment of the present invention, the method for sharing a screen in the virtual reality environment or the environment in which the virtual reality environment and the reality environment coexist will be described in more detail.

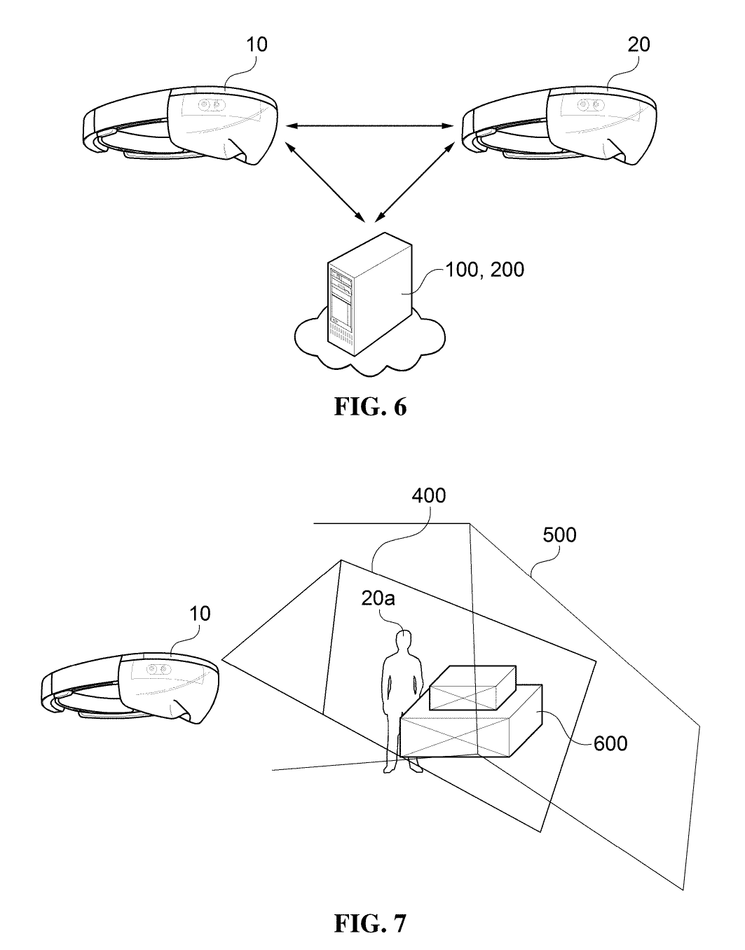

FIG. 6 is a diagram illustrating an example of the method for sharing a screen in the environment including the virtual reality according to the present exemplary embodiment.

FIG. 6 illustrates a case in which mutual screens are shared using a device which can provide the virtual reality environment to the user like the HMD. At this time, the sharer 10 wears his or her own HMD on his/her head, and may share the objects currently displayed in the virtual reality with other sharing subjects 20 on the screen.

In addition, when the HMD provides the mixed reality environment providing the virtual reality together with external reality, it is also possible to share the screen on which the existing real objects and the virtual objects are displayed.

In addition to the sharing between the virtual reality and the user of the virtual reality, it is also possible to share screens between the virtual reality and the mixed reality, the virtual reality and the augmented reality, and the virtual reality and general reality.

At this time, as described above, it is possible for the sharing server 100 to directly transmit the content between the sharer 10 and the sharing subject 20 between the users, and it is also possible to share the screen in a manner in which the media data server 200 streams the media data to the sharing subject when the sharer receives the media data through the external media data server 200.

Specifically describing the example of the sharing, the sharing may be made as illustrated in FIG. 7.

In other words, In other words, referring to FIG. 7, an example in which the screen is shared through the HMD device on the sharer side will be described. A part of the real object, which is recognized as a camera on the sharer side, is provided to the sharing object by streaming, and at the same time, the object displayed as the virtual object can directly be transmitted or can be transmitted through the media data server.

For example, when the sharer 10 shares the screen in the mixed reality environment, an avatar 20a of the sharing subject 200 may be displayed on the display screen 400 of the sharer 10 side together. At this time, a virtual object 600 and the avatar 20a in the mixed reality environment may be implemented on the real space 500.

By doing so, the sharer 10 and the sharing subject 20 may freely transmit and receive a command for the shared objects 600 to or from each other transmit. For example, the sharer 10 and the sharing subject 20 may rotate the virtual object 600 in the virtual real space and exchange opinions.

That is, the sharing server 100 may receive the object control command of the sharer 10 or the sharing subject 20 for the shared virtual object 600, and process the transmitted object data according to the object control command and mutually share the processed result.

Furthermore, FIG. 7 may be equally applied even to the sharing subject 20 in addition to the sharer 10.

For example, even the sharing subject 20 may share the object together with the avatar of the sharer 10, and may receive the processed result according to the command that the sharer 10 inputs to the object in real time. The sharer 10 can transmit the visible real object 500 and the virtual object 600 to the sharing subject 30 and appear as an avatar to freely explain the object. In addition, in the present exemplary embodiment, the method of displaying an avatar can be variously set for each user, and other users may clearly recognize actions or states of the users through the avatar, such that they can share a screen with each other and sympathize and communicate about content displayed on the screen with each other.

First, it is possible to separately select a body part of the avatar according to the method for displaying an avatar, or to customize it according to the user's taste, and these interfaces can be provided as separate menus.

Next, in order to display the action or state of the user through the avatar, it is possible to display a gaze of the other party which is hard to recognize in the 3D virtual space together with the avatar. For example, it is also possible to display a part that other users currently keep an eye on with wearing the HMD device by the avatar's gaze through the virtual dotted line etc. along with the avatar. Apart from this, it is also possible to display a user's intention or a part in which the user is interested through a sign or a gesture of the avatar.

In addition, if the plurality of sharing subjects participate in, the plurality of avatars may be implemented in the virtual space. At this time, if the plurality of avatars contact each other, the reaction thereto can be visualized by the image processing. In this way, users may more realistically communicate with other users.

In addition, in order to express the user's emotion, the user can display emoticon in the virtual reality environment, besides the avatar.

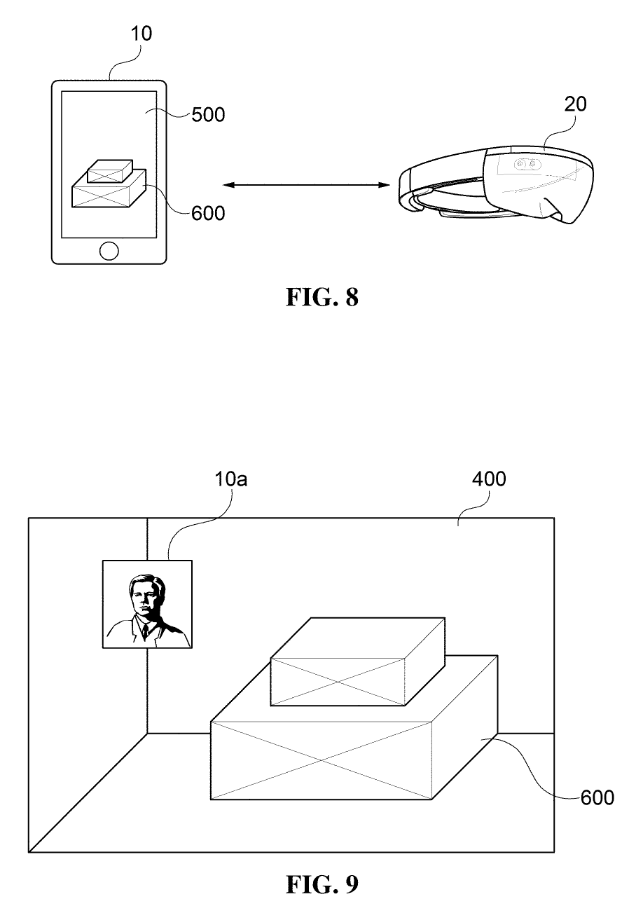

Also, as illustrated in FIG. 8, it is also possible to share the screen between the sharing subject 20 using the HMD and the sharer 10 using a general mobile terminal device such as a smart phone or a tablet PC.

For example, in the case of sharing a screen 500 provided as a display as the augmented reality, referring to FIG. 9, the sharing subject 20 wearing the HMD may receive the image represented by the augmented reality as the virtual object 600 within the virtual reality by allowing the sharer 10 to use the mobile terminal device.

Furthermore, at this time, an image 10a of the sharer 10 may be provided. That is, when the sharer 10 uses the augmented reality through the mobile terminal device, a face image of the sharer 10 can be received through the camera provided on the front of the mobile terminal device, and the HMD of the sharing subject 20 can provide the face image to the sharing subject 20 as the user image 10a in the virtual reality through the graphic processing.

In addition, the user interface for selecting the sharing subject prior to sharing the screen may also be implemented as follows in the virtual reality environment.

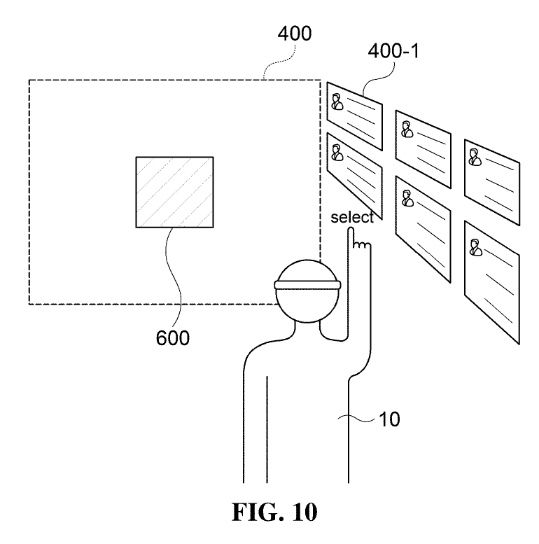

Referring to FIG. 10, the sharer 10 may receive the list of the sharing subjects in the virtual reality environment. As described above, in FIG. 4A, unlike the interface for providing the list of the sharing subjects by overlapping the shared screens with the list, a separate sharing subject list 400-1 is provided to a side surface besides the screen 400 at which the user gazes in the virtual reality environment so that the user can add the sharing subject without disturbing the vision of the object 600 in the virtual reality environment.

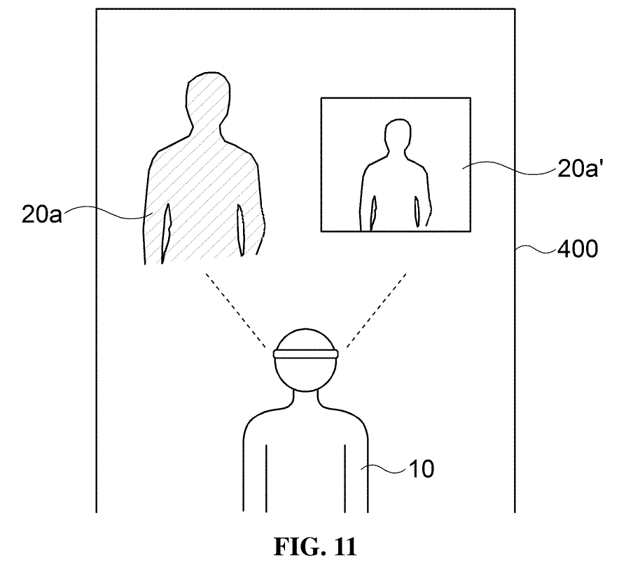

Accordingly, when the plurality of sharing subjects are selected, the sharer 10 can share the screen with the plurality of sharing subjects as well as with one sharing subject. In addition, since the sharing subjects may participate in by using different terminals, as described above, referring to FIG. 11, the sharing subject may be variously displayed within the virtual reality screen 400 by the avatar 20a or a user image 20a′. At this time, in the case of the augmented and mixed realities, the virtual reality screen 400 may be filled with reality environment or filled with the virtual reality environment that the sharer 10 wants.

For example, in a situation such as a remote conference, the virtual reality screen 400 can be implemented and displayed as an image such as a conference room.

That is, in addition to the sharing between the virtual reality and the user of the virtual reality, the sharing method according to the present invention can share screens between the virtual reality and the mixed reality, the virtual reality and the augmented reality, and the virtual reality and the general reality.

In addition, the sharer and the sharing subject sharing the screen can capture the screen to be shared at a specific time to provide the screen displayed to them in different environments to other users to other users and provide it to other users.

At this time, the capture may be performed through the internal interface of the terminal to be used, or may be performed through the interface provided from the service sharing the screen. For example, the user sharing the screen or the user receiving the shared screen with wearing the HMD device in the virtual environment can capture the screen through the physical button of the HMD device. Alternatively, if the user's hand and the virtual reality are displayed and recognized together as in the augmented reality or the mixed reality, it is also possible to receive a capture command through the user's hand action. In addition to the input through the gesture, various input methods such as audio input are also possible.

Furthermore, the method for sharing a screen according to the present invention can further set the background environment information together with the real and virtual objects of the shared screen according to the setting of the sharer or the sharing subject.

In other words, in the case of sharing the screen including the virtual reality in addition to the mere sharing of the screen, it is also possible to separately set a shared background so as to increase the immersion of other sharing subjects.

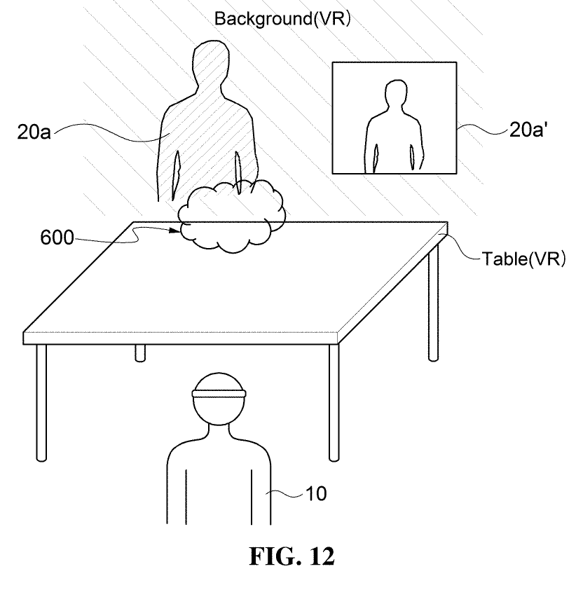

Specifically, referring to FIG. 12, in the present exemplary embodiment, the background environment information that the sharer wants may be set by processing the background as the VR at the time of sharing the screen. At the same time, the virtual table for the shared virtual object 600 is configured as the VR and the communication environment between the sharer 10 and the sharing subjects 20a and 20a′ can be provided.

In addition, for example, when the sharer views and shares sports, spectator seats of sports may be set as the background environment information to another sharing subject and may be implemented as the virtual reality, such that the sharing subjects may feel like watching sports along with the sharer, with seated on the spectator seats of sports.

In addition, in the case of contents related to visiting of art museums or museums and education, background environment information such as a school may be set and shared with objects included in the screen.

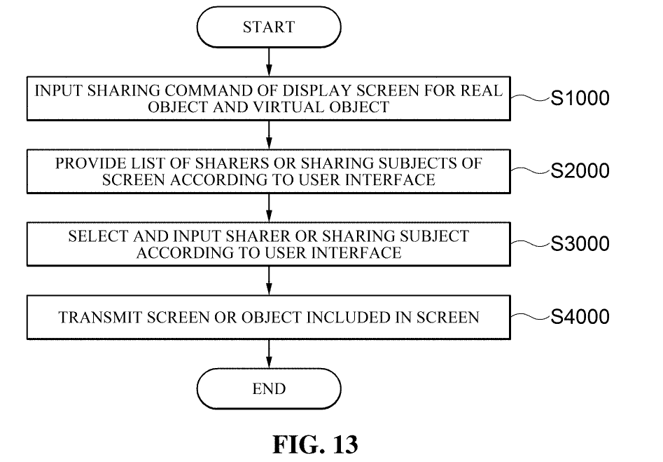

Hereinafter, a method for sharing a screen according to the present exemplary embodiment will be described with reference to FIG. 13.

FIG. 13 is a flow chart showing a sharing method according to the exemplary embodiment of the present invention.

According to the present exemplary embodiment, in the sharing method in multiple environment in which the reality environment and the virtual environment may coexist, first of all, a sharing command of a display screen of a user for the real object received in the reality environment and the virtual object pre-stored or streamed (S1000).

In other words, in the multiple environment, the information on the real objects is input through the camera, and the virtual reality objects are data which are graphically processed and output. In this case, when sharing a screen including the real objects and the virtual objects, each object may be separately transmitted to the sharing subject and the sharing command may also be separately received.

That is, a user may want to share only the virtual objects in the mixed reality, and may want to share the real object or only a part of the real objects.

Accordingly, in the receiving step (S1000), the sharing command is received by separating the real objects from the virtual objects.

Upon receiving the sharing command, the list of the users sharing the screen or the sharing subjects sharing the screen is provided according to the first user interface (S2000). In this case, the user interface may be implemented by changing only the application environment to the above-described interface. That is, the interface represented by the list 404 of the users of FIG. 4A may be implemented as a virtual list object in the virtual reality and provided to the user.

Next, the selection of the user or the sharing subject in the list is received according to the first user interface provided as the list object (S3000). In addition, it is also possible to provide an interface for selecting content to be shared in the virtual reality as described with reference to FIG. 4B along with the selection of the sharing subject.

That is, as illustrated in FIG. 4B, the interface that may select the sharable elements is provided, and the element may be provided as the list of the real objects and the virtual objects.

If the sharing subject is selected, the screen or at least a part of the real object or the virtual object included in the screen may be transmitted so that the screen including at least one of the real object and the virtual object is displayed to the sharing subject (S4000).

Specifically, in the transmitting step (S4000), the real objects may be streamed to the sharing subject by separating the real objects from the virtual subjects. That is, since the real object is a real image input through the camera of the sharer's device, it can be provided to the sharing subject in a streaming form.

Also, since the virtual object may be graphically processed and displayed by the device even in the case of the sharer, the object data for the virtual object is transmitted to the sharing subject and may be visually processed by the device of the sharing subject.

As described above, the method for sharing a screen according to the present exemplary embodiment may also be implemented in the above-described sharing server 100, and the sharing server 100 may be implemented as illustrated in FIG. 2.

In addition, various exemplary embodiments described herein may be implemented in a recording medium that is readable by a computer or a device similar to the computer using, for example, software, hardware, or a combination thereof.

With hardware implementation, exemplary embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electrical units for performing other functions. In some cases, the exemplary embodiments described herein may be implemented by the control module 115 itself.

With software implementation, exemplary embodiments such as procedures and functions described in the present specification may be implemented by separate software modules. Each of the software modules may perform at least one function and operation described herein. A software code may be implemented by software applications written by an appropriate program language. The software code may be stored in a memory module (not illustrated) and executed by the control unit.

According to the exemplary embodiment of the present invention, a user can easily share the screen with another user during the execution of the media data, and the process according to the sharing of the copyrighted media data can be performed to solve the problem of the screen sharing between a user and a sharing subject and protect the right of a copyright holder.

Further, an object to be shared in multiple environment is selected and shared, and there is no need to change a state to separate reality for sharing in the current reality.

In addition, the user can more easily recognize the other party and remote users can realistically share the content with each other, according to the methods for transmitting the mutual interface command between the sharer and the sharing subject and displaying the other party depending on each environment.

According to the exemplary embodiment of the present invention, a user can easily share the screen with another user during the execution of the media data, and the process according to the sharing of the copyrighted media data can be performed to solve the problem of the screen sharing between a user and a sharing subject and protect the right of a holder of copyright.

Further, there is no need to select and share an object to be shared in multiple environment and change a state to separate reality for sharing in the current reality.

In addition, the user can more easily recognize the other party and remote users can realistically share the content with each other, according to the methods for transmitting the mutual interface command between the sharer and the sharing subject and displaying the other party depending on each environment.

The spirit of the present disclosure has been just exemplified. It will be appreciated by those skilled in the art that various modifications, alterations, and substitutions can be made without departing from the essential characteristics of the present disclosure.

Accordingly, the exemplary embodiments disclosed in the present invention and the accompanying drawings do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

What is claimed is:

1. A method for sharing a user screen, comprising:
receiving a sharing command of a display screen of a user for content pre-stored or displayed in streaming;
providing a list of sharers sharing the screen or sharing subjects receiving the shared screen according to a first user interface;
receiving a selection of the sharer or the sharing subject in the list according to the first user interface; and
transmitting the screen or at least a part of content included in the screen so that the screen is displayed to the sharing subject.

2. The method of claim 1, wherein a screen displayed to the sharing subject is displayed together in at least one area of the screen displayed to the sharer according to a second user interface.

3. The method of claim 1, wherein in the providing, a selection menu of a sharing mode of the screen is provided according to the first user interface.

4. The method of claim 1, wherein in the transmitting, an image data output to the screen or the content included in the screen is transmitted to the sharing subject in the streaming.

5. The method of claim 1, wherein in the transmitting, the content is transmitted to the sharing subject in the streaming through a media data server managing the content by referring to sync provided to the sharer.

6. The method of claim 5, wherein in the transmitting, a data for a unit time of the content is transmitted in the streaming based on the sync.

7. The method of claim 2, wherein the second user interface includes an interface element for switching the screen of the sharing subject displayed in the one area to an image of the sharing subject or an avatar image of the sharing subject.

8. The method of claim 1, wherein the first user interface includes an interface element for selecting at least a part of the content included in the screen.

9. A server system, comprising:
a memory;
a processor; and
a sharer screen sharing module included in the memory and executed by the processor, wherein the sharer screen sharing module performs receiving a sharing command of a display screen of a user for content pre-stored or displayed in streaming;
providing a list of sharers sharing the screen or sharing subjects getting a request of the screen sharing according to a first user interface;
receiving a selection of the sharer or the sharing subject in the list according to the first user interface; and
transmitting the screen or at least a part of content included in the screen so that the screen is displayed to the sharing subject.

10. The server system of claim 9, wherein the sharer screen sharing module displays a screen displayed to the sharing subject in at least a part of the screen displayed to the sharer according to a second user interface.

11. The server system of claim 9, wherein the sharer screen sharing module provides a selection menu of a sharing mode of the screen according to the first user interface.

12. The server system of claim 9, wherein the sharer screen sharing module transmits an image data output to the screen or the content included in the screen to the sharing subject in the streaming.

13. The server system of claim 9, wherein in the transmitting, the content is transmitted to the sharing subject in the streaming through a media data server managing the content by referring to sync provided to the sharer.

14. The server system of claim 13, wherein in the transmitting, a data for a unit time of the content is transmitted in the streaming based on the sync.

15. The server system of claim 10, wherein the second user interface includes an interface element for switching the screen of the sharing subject displayed in the one area to an image of the sharing subject or an avatar image of the sharing subject.

16. The server system of claim 9, wherein the first user interface includes an interface element for selecting at least a part of the content included in the screen.

17. A non-transitory computer-readable recording medium in which a program is stored, the program executing:
receiving a sharing command of a display screen of a user for content pre-stored or displayed in streaming;
providing a list of sharers sharing the screen or sharing subjects getting a request of the screen sharing according to a first user interface;
receiving a selection of the sharer or the sharing subject in the list according to the first user interface; and
transmitting the screen or at least a part of content included in the screen so that the screen is displayed to the sharing subject.

18. A method for sharing a user screen, comprising:
receiving a sharing command of a display screen of a user for a received real object in reality environment and a virtual object pre-stored or streamed;
providing a list of sharers sharing the screen or sharing subjects getting a request of the screen sharing according to a first user interface;
receiving a selection of the sharer or the sharing subject in the list according to the first user interface; and
transmitting the screen or at least a part of the real object or the virtual object included in the screen so that a screen including at least one of the real object and the virtual object is displayed to the sharing subject.

19. The method of claim 18, wherein in the transmitting, the real object and the virtual object is divided to stream the real object to the sharing subject and an object data of the virtual object is transmitted to the sharing subject.

20. The method of claim 19, further comprising:
receiving a command of the sharer or the sharing subject for the shared virtual object as an object control command and processing the transmitted object data according to the object control command to mutually share the processed result.

21. The method of claim 18, wherein in the transmitting, an image of the sharer or an avatar image of the sharer is transmitted together.

22. The method of claim 21, wherein in the transmitting, the image of the sharer received through a sharer terminal providing augmented reality to the sharer is transmitted to the sharing subject.

23. The method of claim 21, wherein in the transmitting, the avatar image of the sharer is transmitted to the sharing subject through the sharer terminal providing virtual reality or mixed reality in which virtual and augmented realities are mixed to the sharer.

24. The method of claim 18, wherein in the transmitting, background environment information set by the sharer is transmitted along with the real object or the virtual object.

25. The method of claim 18, further comprising:
receiving a screen capture command including the transmitted real object or virtual object,
wherein in the transmitting, a capture screen is transmitted to the sharer or the sharing subject.

26. A server system, comprising:
a memory;
a processor; and
a sharer screen sharing module included in the memory and executed by the processor, wherein the sharer screen sharing module performs receiving a sharing command of a display screen of a user for a received real object of reality environment and a virtual object pre-stored or streamed;
providing a list of sharers sharing the screen or sharing subjects getting a request of the screen sharing according to a first user interface;
receiving a selection of the sharer or the sharing subject in the list according to the first user interface; and
transmitting the screen or at least a part of the real object or the virtual object included in the screen so that a screen including at least one of the real object and the virtual object is displayed to the sharing subject.

27. A non-transitory computer-readable recording medium in which a program is stored, the program executing:
receiving a sharing command of a display screen of a user for a received real object of reality environment and a virtual object pre-stored or streamed;
providing a list of sharers sharing the screen or sharing subjects getting a request of the screen sharing according to a first user interface;
receiving a selection of the sharer or the sharing subject in the list according to the first user interface; and
transmitting the screen or at least a part of the real object or the virtual object included in the screen so that a screen including at least one of the real object and the virtual object is displayed to the sharing subject.
